(19) United States
(12) Patent Application Publication
(10) Pub. No.: US 2020/0106635 A1
(43) Pub. Date: Apr. 2, 2020

(54) REMOTE OPERATION OF APPLIANCE OVER WIRED CONNECTION

(71) Applicant: Haier US Appliance Solutions, Inc., Wilmington, DE (US)

(72) Inventors: Je Kwon Yoon, Seongnam (KR); Woong Jeon, Hwaseong (KR); Janghwan Hahn, Louisville, KY (US)

(21) Appl. No.: 16/143,559

(22) Filed: Sep. 27, 2018

(51) Int. Cl. H04L 12/28; G05B 15/02; H04B 10/114; H04W 88/04

(52) U.S. Cl. CPC H04L 12/2816; G05B 15/02; H04B 10/1149; H04L 2012/285; H04W 88/04; G05B 2219/2642; H04L 12/2838

(57) ABSTRACT

A method of operating an appliance includes receiving a first signal from a remote user interface device with a wireless communication module of a first appliance. The first signal includes a command for a second appliance. The method then includes transmitting a second signal from the first appliance to the second appliance over a wired connection. The second signal also includes the command for the second appliance. The method then includes modifying an operational status of a component of the second appliance based on the command.

### FIELD OF THE INVENTION

The present subject matter relates generally to household appliances, and more particularly to appliances which receive data and commands remotely without including a wireless module.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a cooktop, a microwave, and/or a refrigerator, along with room air conditioners and other various appliances. Generally, each such appliance must include a wireless communication module in order to utilize remote operation functions of the appliances, such as activating or otherwise modifying the operational status of one or more components of the appliance from a remote user interface device and/or transmitting data, such as operational status information to a remote user interface device.

However, the inclusion of a wireless communication module can increase the cost of the household appliance. Further, each appliance in a home that has a wireless module onboard the appliance will need to be separately commissioned in order to establish at least an initial wireless connection with the household appliance. When there are multiple wireless household appliances in a home, the commissioning process can be time consuming.

Accordingly, there exists a need for a household appliance with improved features for remote interaction with a user.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating an appliance is provided. The method includes receiving a first signal from a remote user interface device with a wireless communication module of a first appliance. The first signal includes a command for a second appliance. The method then includes transmitting a second signal from the first appliance to the second appliance over a wired connection. The second signal also includes the command for the second appliance. The method then includes modifying an operational status of a component of the second appliance based on the command.

In accordance with another embodiment of the present disclosure, a group of appliances is provided. The group of appliances includes a first appliance. The first appliance includes a cabinet extending between a top side and a bottom side along a vertical direction and between a left side and a right side along a lateral direction. The vertical direction and the lateral direction are mutually perpendicular. The first appliance also includes a wireless communication module configured to communicate wirelessly with a remote user interface device and a wired communication module. A controller is communicatively coupled to the wireless communication module and the wired communication module. The group of appliances also includes a second appliance. The second appliance includes a cabinet separate and distinct from the cabinet of the first appliance. The cabinet of the second appliance extends between a top side and a bottom side along the vertical direction and between a left side and a right side along the lateral direction. The second appliance also includes a wired communication module connected to the wired communication module of the first appliance and a controller communicatively coupled to the wired communication module of the second appliance. The controller of the first appliance is configured for receiving a first signal from the remote user interface device via the wireless communication module. The first signal includes a command for the second appliance. The controller of the first appliance is also configured for transmitting a second signal to the second appliance using the wired communication module of the first appliance. The second signal includes the command for the second appliance. The controller of the second appliance is configured for receiving the second signal from the wired communication module of the first appliance using the wired communication module of the second appliance and modifying an operational status of a component of the second appliance based on the command.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary pair of laundry appliances in accordance with one or more embodiments of the present disclosure.

FIG. 2 provides a side cross-sectional view of the one of the exemplary laundry appliances of FIG. 1.

FIG. 3 provides a perspective view of the other exemplary laundry appliance of FIG. 1 with portions of a cabinet of the laundry appliance removed to reveal certain components of the laundry appliance.

FIG. 4 provides a front view of an exemplary group of kitchen appliances in accordance with additional embodiments of the present disclosure.

FIG. 5 provides a side schematic view of the group of kitchen appliances of FIG. 2.

FIG. 6 provides a perspective view of a microwave oven appliance which may be one of a group of kitchen appliances in accordance with additional embodiments of the present disclosure.

FIG. 7 provides a schematic view of a second appliance communicating with a remote user interface device via a first appliance.

FIG. 8 provides a flowchart illustrating an example method of operating a second appliance based on a command received from a remote user interface device via a first appliance according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

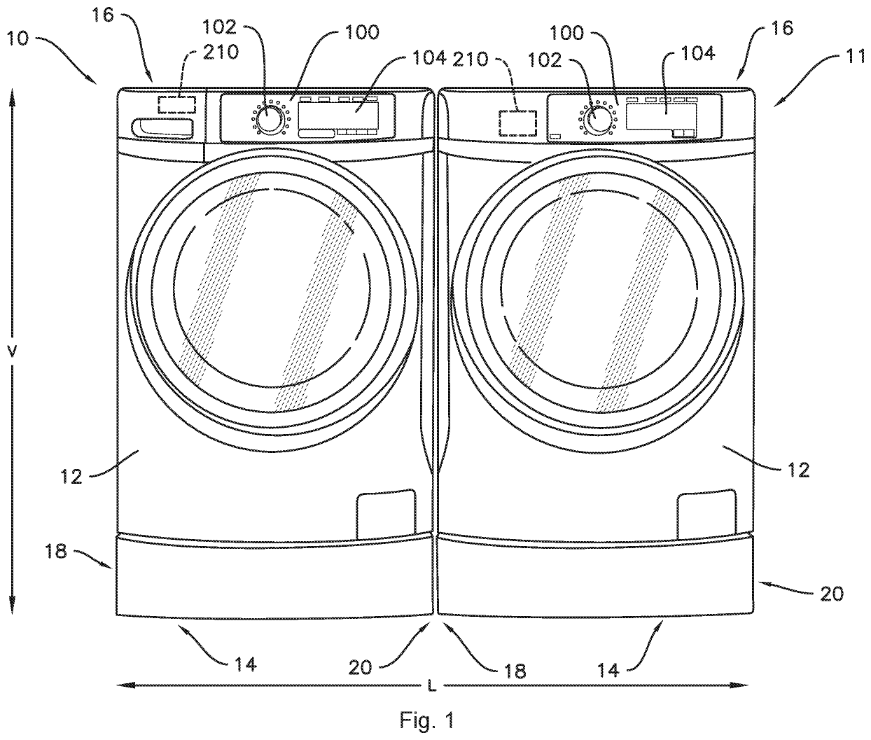

As may be seen in FIGS. 1-6, in accordance with one or more embodiments of the present subject matter, a group of appliances including at least a first appliance 10 and a second appliance 11 is provided. As will be described in more detail below, in various embodiments, the second appliance 11 may be configured to receive a command remotely, e.g., from a remote device that transmits a wireless signal with a command for the second appliance 11 encoded therein, via the first appliance 10, e.g., where the first appliance 10 receives the wireless signal and then transmits a signal to the second appliance 11. The illustrated group of two appliances is provided by way of example only. Various embodiments of the present subject matter may also include three or more appliances, wherein one appliance of the group of three of more appliances transmits and receives wireless signals and relays signals to the remaining two or more appliances of the group via wired connections.

As generally seen throughout FIGS. 1-6, each appliance 10 and 11 includes a cabinet 12 which defines a vertical direction V, a lateral direction L and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and a front side 22 and a rear side 24, e.g., along the transverse direction T.

Each appliance 10 and 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance 10 and 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliances 10 and 11. Operation of the appliances 10 and 11 may each be regulated by the respective controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 or 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIGS. 1 through 3, the group of appliances 10 and 11 may be a pair of laundry appliances. In the exemplary embodiment illustrated in FIG. 1, the first appliance may be a washing machine appliance 10 and the second appliance may be a clothes dryer 11. In other embodiments, the washing machine appliance may be the second appliance and the clothes dryer may be the first appliance. In embodiments such as illustrated in FIG. 1, the user input device 102 of each appliance 10 and 11 may be positioned on the user interface panel 100. The embodiment illustrated in FIG. 1 also includes a display 104 on the user interface panel.

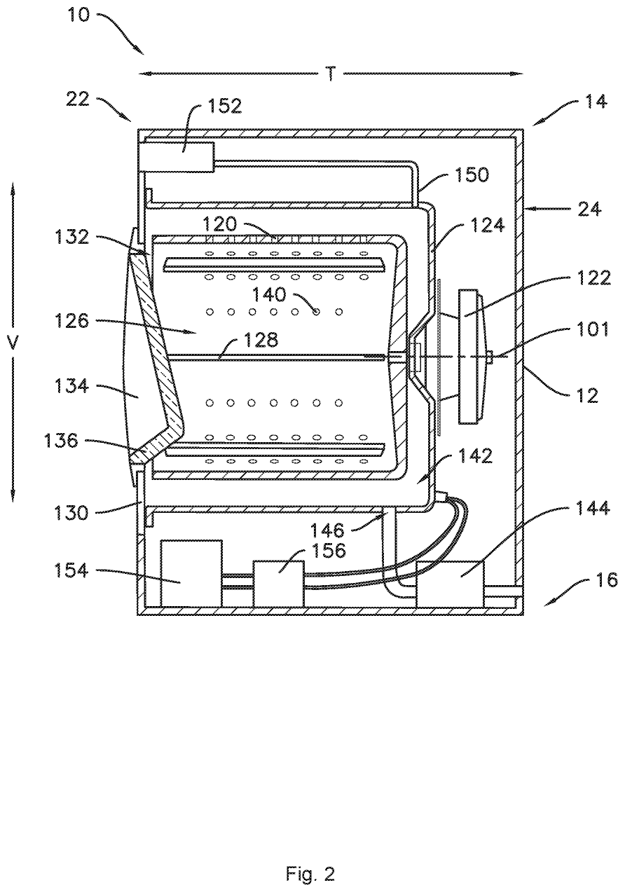

Referring to FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 102. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. Other washing machine appliances having different configurations, different appearances, and/or different features may also be utilized with the present subject matter as well, e.g., vertical axis washing machine appliances.

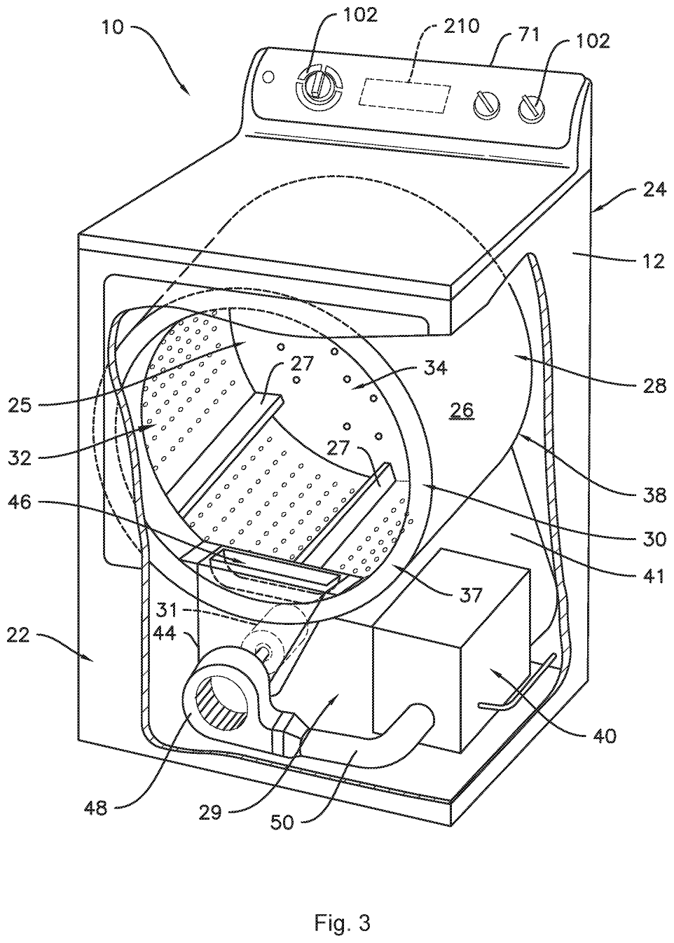

FIG. 3 provides a perspective view of the dryer appliance 11 of FIG. 1 with a portion of a cabinet or housing 12 of dryer appliance 11 removed in order to show certain components of dryer appliance 10. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 102 may be programmed to operate dryer appliance 10 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

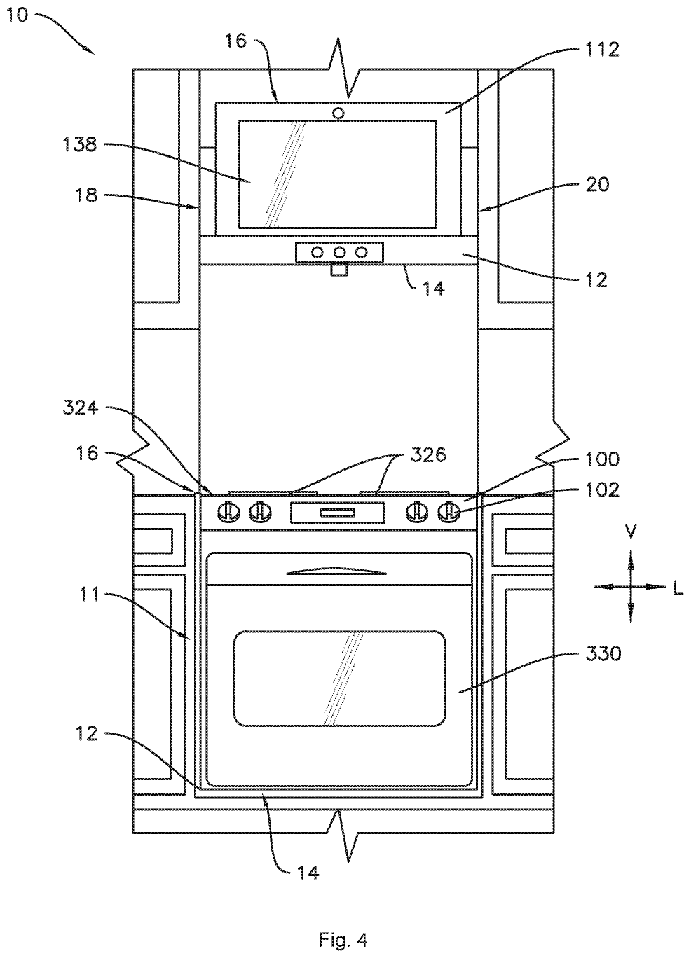

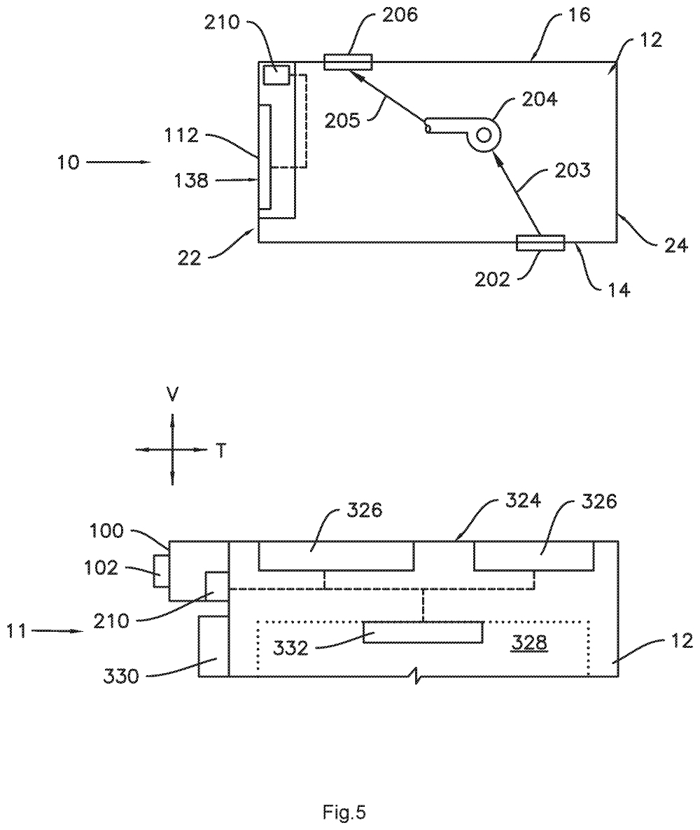

FIGS. 4 and 5 illustrate another example embodiment of a group of appliance where the first appliance 10 and the second appliance 11 are kitchen appliances. In this example, the first appliance 10 is a user engagement system which includes an image monitor 112 that is generally positioned above a cooktop appliance 11, e.g., along the vertical direction V. Image monitor 112 may include a touchscreen capable of receiving a user input by detecting and responding to a touch on a surface of the image monitor 112.

As shown, cooktop appliance 11 includes a chassis or cabinet 12 that extends along the vertical direction V between a top side 16 and a bottom side 14. Cooktop appliance 11 can include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber 328 selectively enclosed by a door 330. One or more heating elements 332 (e.g., top broiling elements or bottom baking elements) may be positioned within cabinet 12 of cooktop appliance 11 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 can selectively activate and operate these various components. Various components of cooktop appliance 11 are communicatively coupled with controller 210 via one or more communication lines such as, for example, conductive signal lines, shared communication busses, or wireless communications bands.

As shown in FIGS. 4 and 5, the cabinet 12 the first appliance 10 may be or include one or more casings (e.g., a hood casing) provided above cooktop appliance 11 along the vertical direction V. For example, a hood casing 12 may be positioned above cooktop appliance 11. Hood casing 12 includes a plurality of outer walls and generally extends along the vertical direction V between a top side 16 and a bottom side 14, along the lateral direction L between a right side 18 and a left side 20, e.g., “right” and “left” as used herein refer to from a perspective of a user standing in front of the appliance 10. As shown in FIG. 5, the hood casing 12 may also extend along the transverse direction T between a front end 22 and a back end 24. In some embodiments, hood casing 12 is spaced apart from cooktop surface 324 along the vertical direction V such that an open region is defined therebetween.

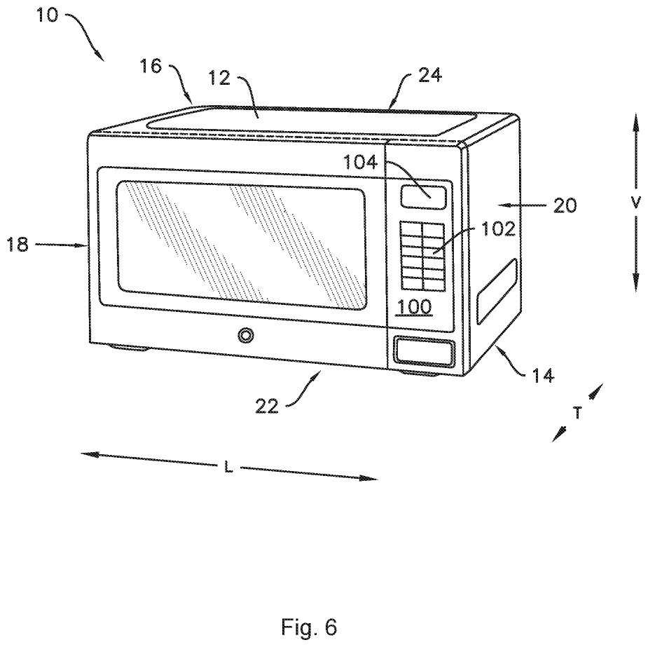

As shown in FIG. 5, in kitchen appliance embodiments, one of the group of appliances 10 and 11 may be or include a ventilation assembly within hood casing 12 which is configured to direct an airflow from the open region between the appliances 10 and 11 and through hood casing 12 of the upper appliance, e.g., which is indicated as first appliance 10 in the example illustrations of FIGS. 4 and 5, but which may instead be the second appliance 11, e.g., when the cooktop appliance is the first appliance 10. A range hood is provided by way of example only. Other configurations may be used within the spirit and scope of the present disclosure. For example, although a generally rectangular shape is illustrated, any suitable shape or style may be adapted to form the structure of hood casing 12. As another example, a microwave oven 10 (FIG. 6), as described in more detail below, may be provided as well as or instead of the hood.

In some embodiments, an image monitor 112 may be provided above cooktop surface 324 (e.g., along the vertical direction V). For instance, image monitor 112 may be mounted to or supported on hood casing 12 of the first appliance 10 (e.g., directly above cooktop surface 324) proximal to the front side 22. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 12 forward from imaging surface 138 along the transverse direction T.

As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of the first appliance 10 or cooktop appliance 11. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel), sensors overlaid across imaging surface 138, or any other suitable input.

As illustrated, the imaging surface 138 is directed toward the area forward from the cooktop appliance 11. During use, a user standing in front of cooktop appliance 11 may thus see the optically-viewable picture (e.g., recipe, dynamic video stream, graphical user interface, etc.) displayed at the imaging surface 138.

As mentioned, the first appliance 10 may be or include a ventilation assembly (and the ventilation assembly may also be the second appliance 11, e.g., when the cooktop appliance is the first appliance 10). In such embodiments, one or more air outlets 206 may be defined by hood casing 12 (e.g., through one or more external walls of hood casing 12). As shown for example in FIG. 5, air outlet 206 defined through hood casing 12 may be defined through hood casing 12 at the top side 16. The ventilation system may generally extend between one or more air inlets 202 defined in the bottom side 14 of the casing 12 and air outlet 206. For example, the bottom side 14 of the casing 12 of the first appliance 10 may face the cooktop surface 324 of the cooktop appliance 11. The ventilation system may also include an air handler 204 fixedly mounted within the casing 12 in fluid communication with the air inlet 202 to motivate an intake flow of air 203 through the inlet 202 to the air handler 204 and an exhaust flow of air 205 from the air handler 204 to the outlet 206.

As will be understood, air handler 204 may be provided as any suitable blower or fan (e.g., radial fan, tangential fan, etc.) positioned within hood casing 12 to actively rotate or motivate air, steam, or vapors 203 into and through air inlet 202. Optionally, one or more filters (not pictured) may be provided at inlet 202 to clean the air, steam, or vapors 203 as it enters hood casing 12 from the open region between the first and second appliances 10 and 11. For instance, a grease filter having a suitable coarse filter medium, such as a metallic mesh including aluminum or stainless steel, may be mounted across inlet 202. Additionally or alternatively, an odor filter having a suitable fine filter medium, such as a mesh or block including activated carbon, may be mounted across inlet 202. Optionally, the odor filter may be positioned above or downstream from the grease filter.

In another example embodiment, the first appliance 10 or the second appliance 11 may be a microwave oven appliance, such as is illustrated in FIG. 6. For example, the microwave appliance 10 of FIG. 6 may be one of the group of kitchen appliances illustrated in FIGS. 4 and 5, e.g., in combination with or instead of the image assembly and fume hood. It should be understood that microwave oven appliance 10 is provided by way of example only. Thus, the present subject matter is not limited to microwave oven appliance 10 and may be utilized in any suitable appliance. Moreover, in further embodiments, the microwave oven may be a third appliance of the group, and may be connected by a wired connection to both a cooktop or oven appliance and a user engagement system, where one of the microwave oven appliance, the cooktop appliance, and the user engagement system includes a wireless communication module.

Microwave oven appliance 10 includes a cabinet 12. A cooking chamber is defined within the cabinet 12 of the microwave 10. Microwave 10 of FIG. 6 is configured to heat articles, e.g., food or beverages, within the cooking chamber using a heating assembly that emits electromagnetic radiation. The heating assembly of the microwave appliance 10 may include various components which operate to produce the electromagnetic radiation, as is generally understood. For example, microwave appliance 10 may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

According to various embodiments of the present disclosure, the group of appliances 10 and 11 may take the form of any of the examples described above, or may be any other household appliance where improved remote operation is desired. Thus, it will be understood that the present subject matter is not limited to any particular household appliance.

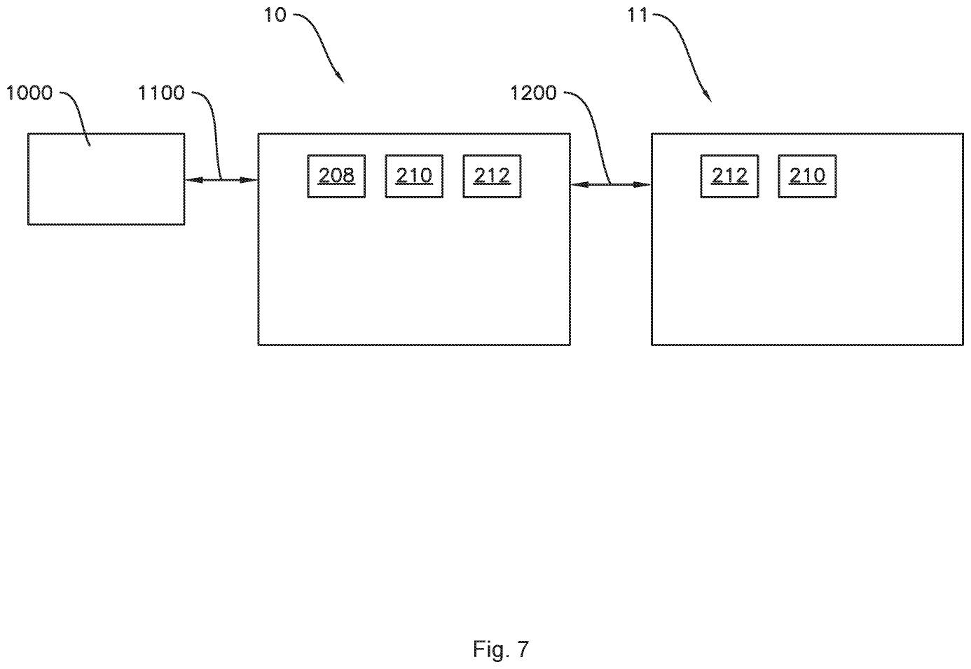

FIG. 7 provides a schematic view of a second appliance 11 communicating with a remote user interface device 1000 via a first appliance 10. As shown in FIG. 7, the first appliance 10, and in particular, controller 210 thereof, may be configured to communicate with a separate device external to the appliance, such as a communications device or other remote user interface device 1000. The remote user interface device 1000 may be a laptop computer, smartphone, tablet, personal computer, wearable device, smart home system, and/or various other suitable devices. The first appliance 10 may include a wireless communication module 208 which is configured to communicate with the remote user interface device 1000 device through various possible communication connections and interfaces, e.g., such as Zigbee, BLUETOOTH®, WI-FI®, or any other suitable communication connection.

In various embodiments, wireless module 208 includes a network interface such that the controller 210 of the first appliance 10 can connect to and communicate over one or more networks with one or more network nodes. Wireless module 208 can also include one or more transmitting, receiving, or transceiving components for transmitting/receiving communications with other devices communicatively coupled with first appliance 10.

The remote user interface device 1000 may include a memory for storing and retrieving programming instructions. For example, the remote user interface device 1000 may be a smartphone operable to store and run applications, also known as “apps,” and may include a remote user interface provided as a smartphone app.

The first appliance 10 and the remote user interface device 1000 may be matched in wireless communication, e.g., may be wirelessly connected via the wireless module 208. The first appliance 10 may receive a first signal 1100, e.g., a wireless signal, from the remote user interface device 1000 over the wireless connection. The signal 1100 sent from the remote user interface device 1000 may include data encoded therein, including a command for the second appliance 11.

The first appliance 10 may include a wired communication module 212 and the second appliance 11 may also include a wired communication module 212 connected to the wired communication module 212 of the first appliance 10 by a wired connection, e.g., such as a LAN cable with RJ45 connectors, CAT-5 cable, or USB cable. The controller 210 of the first appliance 10 may be configured for transmitting a second signal 1200, e.g., a wired signal, from the first appliance 10 to the second appliance 11 over the wired connection. The second signal 1200 may include the command for the second appliance 11 received by the first appliance 10 from the remote user interface device 1000 encoded therein. The controller 210 of the second appliance 11 may be configured for receiving the second signal 1200 from the wired communication module 212 of the first appliance 10 using the wired communication module 212 of the second appliance 11. Based on the command encoded in the second signal 1200, the command having been received by the second appliance 11 from the remote user interface device 1000 via the first appliance 10, the controller 210 of the second appliance 11 may modify an operational status of a component of the second appliance 11. As shown in FIG. 7, in at least some embodiments, the second appliance 11 may not include a wireless communication module.

As shown in FIG. 7, the signals 1100 and 1200 may be transmitted and received in both directions, e.g., to and from each of the remote user interface device 1000, the first appliance 10, and the second appliance 11. For example, the second appliance 11 may also be configured for transmitting, using the wired communication module 212 of the second appliance 11, a signal 1200 to the first appliance 10, where the signal 1200 from the second appliance 11 includes an operational status information of one or more components of the second appliance 11. The first appliance 10 may then transmit a wireless signal 1100 to the remote user interface device 1000, the wireless signal 1100 including the operational status information received by the first appliance 10 from the second appliance 11. Thus, operational status of the second appliance 11 may be viewable on the remote user interface device which is wirelessly connected to the first appliance 10 without making a direct wireless connection from the remote user interface device 1000 to the second appliance 11, e.g., where the second appliance 11 does not include a wireless communication module.

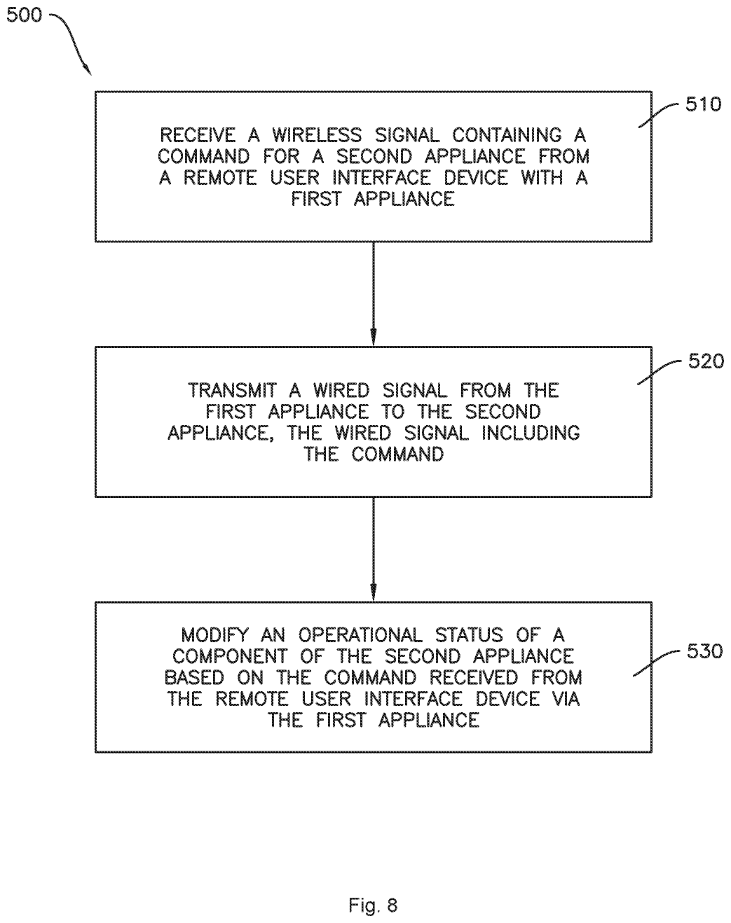

FIG. 8 provides a flowchart illustrating an example method 500 of operating a second appliance 11 based on a command received from a remote user interface device 1000 via a first appliance 10. As shown in FIG. 8, the method 500 may include a step 510 of receiving a first signal 1100 from a remote user interface device 1000 with a wireless communication module 208 of a first appliance 10. The first signal 1100 may include a command for a second appliance 11.

The method 500 may proceed to a step 520 of transmitting a second signal 1200 from the first appliance 10 to the second appliance 11 over a wired connection, e.g., via a cable connecting the wired communication module 212 of the first appliance 10 to the wired communication module 212 of the second appliance 11. The second signal 1200 includes the command for the second appliance 11.

The method 500 may then include a step 530 of modifying an operational status of a component of the second appliance 11 based on the command received from the remote user interface device 1000 via the first appliance 10.

For example, in some embodiments, the appliances 10 and 11 may be laundry appliances, e.g., one of the washing machine appliance and clothes dryer illustrated in FIG. 1 may be the first appliance having a wireless communication module and the other may be the second appliance which does not have a wireless communication module. In such embodiments, the laundry appliances 10 and 11 may be configured to perform a selected one of several cycles, such as a cycle including a high temperature wash and low temperature rinse in the case of a washing machine appliance, or a selected one of a high temperature drying cycle, low temperature drying cycle, or tumble dry cycle in the case of a clothes dryer appliance.

For example, the clothes dryer appliance may be the second appliance and may include components such as those illustrated for example in FIGS. 1 and 3. In such embodiments, modifying the operational status of the component of the clothes dryer appliance may include starting a drying cycle of the clothes dryer appliance, and/or modifying a temperature setting of a heater 40 of the clothes dryer appliance. As another example, the washing machine appliance may be the second appliance and may include components such as those illustrated for example in FIGS. 1 and 2. In such embodiments, modifying the operational status of the component of the washing machine appliance may include starting a washing cycle or setting a delay timer for a washing cycle. In another example, modifying the operational status of the component of the washing machine appliance may include modifying a spin speed of a basket 120 of the washing machine appliance, e.g., by modifying operational speed of the motor 122. As additional examples, modifying the operational status of either of the laundry appliances in various embodiments may include selecting a desired cycle, such as cotton, jeans, speed wash or dry, etc. Additional embodiments within the scope of the present disclosure may include any other suitable operational status of a washer or dryer appliance, as will be understood by those of skill in the art. Thus, a laundry cycle, e.g., a washing or drying cycle, of the second appliance 11 is another example of a an operational status of a component of the second appliance which may be modified based on the command received from the remote user interface device via the first appliance in an improved second appliance according to the present subject matter as described herein throughout.

In some embodiments, the second appliance 11 may include a fan. For example, the second appliance 11 may be a fume hood as in FIGS. 4 and 5 including a fan 204 (FIG. 5). In some embodiments, the fume hood may be second appliance 11, and a rotational speed of the fan 204 may be an operational status of a component of the fume hood which is adjusted based on the command received from the remote user interface device 1000 via the first appliance 10. Thus, a speed of rotation of a fan 204 is another example of an operational status or setting which may be modified in an improved second appliance 11 according to the present subject matter as described herein throughout.

In various embodiments, the second appliance 11 may be a cooking appliance such as the cooktop appliance of FIGS. 4 and 5 or the microwave appliance of FIG. 6. In such embodiments, the operational status of a component of the second appliance which is modified based on the command may include one or both of a cooking time and a cooking temperature, such as a power level of an cooktop heating element 326 (e.g., as shown in FIGS. 4 and 5) or of a heating assembly of the microwave, e.g., as shown in FIG. 6. For example, modifying the operational status of the component of the microwave oven appliance may include activating a heating assembly of the microwave oven appliance. As another example, modifying the operational status of the component of the cooktop appliance may include modifying a heat output level of a heating element 326 and/or 332 of the cooktop appliance. As another example, modifying the operational status may include selecting any suitable operational setting or cycle of a cooking appliance, such as a broil setting, initiating a preheat cycle, or a self-clean cycle of an oven appliance, or such as a popcorn cycle of a microwave oven appliance. Additional embodiments within the scope of the present disclosure may include any other suitable operational status of a kitchen appliance, as will be understood by those of skill in the art. Thus, exemplary methods may include, and/or the controller 210 may be configured for, automatically selecting a cooking time and a cooking temperature based on the command received from the remote user interface device 1000 via the first appliance 10, as yet another example which may be provided in an improved appliance according to the present subject matter as described herein throughout.

The present disclosure provides several advantages which will be apparent to those of ordinary skill in the art. For example, where the first appliance 10 and the second appliance 11 are connected via the wired connection as shown and described above, the group of appliances 10 and 11 may be commissioned, e.g., may be set up for wireless communication and establish an initial connection to a wireless network, in a single commissioning operation without the need to separately commission each of the first appliance 10 and the second appliance 11. As another example, the cost and complexity of the second appliance 11 may be reduced by omitting a wireless communication module from the second appliance 11. By communicating with the second appliance 11 via the first appliance 10 as disclosed herein, a remote user interface device 1000 may be provided full control and full access to the second appliance 11.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, the method comprising:
receiving a first signal from a remote user interface device with a wireless communication module of a first appliance, the first signal comprising a command for a second appliance;
transmitting a second signal from the first appliance to the second appliance over a wired connection, the second signal comprising the command for the second appliance; and
modifying an operational status of a component of the second appliance based on the command.

2. The method of claim 1, further comprising transmitting a third signal from the second appliance to the first appliance over the wired connection, wherein the third signal comprises an operational status information of one or more components of the second appliance, and transmitting a fourth signal to the remote user interface device with the wireless communication module of the first appliance, the fourth signal comprising the operational status information of the one or more components of the second appliance.

3. The method of claim 1, wherein the first appliance is a washing machine appliance and the second appliance is a clothes dryer appliance.

4. The method of claim 3, wherein modifying the operational status of the component of the clothes dryer appliance comprises starting a drying cycle.

5. The method of claim 3, wherein modifying the operational status of the component of the clothes dryer appliance comprises modifying a temperature setting of a heater of the clothes dryer appliance.

6. The method of claim 1, wherein the first appliance is a clothes dryer appliance and the second appliance is a washing machine appliance.

7. The method of claim 6, wherein modifying the operational status of the component of the washing machine appliance comprises setting a delay timer for a washing cycle.

8. The method of claim 6, wherein modifying the operational status of the component of the washing machine appliance comprises modifying a spin speed of a basket of the washing machine appliance.

9. The method of claim 1, wherein the first appliance is a cooktop appliance and the second appliance is a fume hood.

10. The method of claim 9, wherein modifying the operational status of the component of the fume hood comprises modifying a rotational speed of a fan of the fume hood.

11. The method of claim 1, wherein the first appliance is a cooktop appliance and the second appliance is a microwave oven appliance.

12. The method of claim 11, wherein modifying the operational status of the component of the microwave oven appliance comprises activating a heating assembly of the microwave oven appliance.

13. The method of claim 1, wherein the first appliance is a fume hood and the second appliance is a cooktop appliance.

14. The method of claim 13, wherein modifying the operational status of the component of the cooktop appliance comprises modifying a heat output level of a heating element of the cooktop appliance.

15. The method of claim 1, wherein the first appliance is a microwave oven appliance and the second appliance is a cooktop appliance.

16. The method of claim 15, wherein modifying the operational status of the component of the cooktop appliance comprises modifying a heat output level of a heating element of the cooktop appliance.

17. A group of appliances in operative communication over a wired connection, the group of appliances comprising:
a first appliance comprising:
a cabinet extending between a top side and a bottom side along a vertical direction and between a left side and a right side along a lateral direction, the vertical direction and the lateral direction are mutually perpendicular;
a wireless communication module configured to communicate wirelessly with a remote user interface device;
a wired communication module; and
a controller communicatively coupled to the wireless communication module and the wired communication module;
a second appliance comprising:
a cabinet separate and distinct from the cabinet of the first appliance, the cabinet of the second appliance extending between a top side and a bottom side along the vertical direction and between a left side and a right side along the lateral direction;
a wired communication module connected to the wired communication module of the first appliance; and
a controller communicatively coupled to the wired communication module of the second appliance;
wherein the controller of the first appliance is configured for:
receiving a first signal from the remote user interface device via the wireless communication module, the first signal comprising a command for the second appliance; and
transmitting a second signal to the second appliance using the wired communication module of the first appliance, the second signal comprising the command for the second appliance;
wherein the controller of the second appliance is configured for:
receiving the second signal from the wired communication module of the first appliance using the wired communication module of the second appliance; and
modifying an operational status of a component of the second appliance based on the command.

18. The group of appliances of claim 17, wherein the controller of the second appliance is further configured for transmitting a third signal to the first appliance using the wired communication module of the second appliance, wherein the third signal comprises an operational status information of one or more components of the second appliance and wherein the controller of the first appliance is further configured for transmitting a fourth signal to the remote user interface device with the wireless communication module of the first appliance, the fourth signal comprising the operational status information of the one or more components of the second appliance.

19. The group of appliances of claim 17, wherein the second appliance does not include a wireless communication module.

20. The group of appliances of claim 17, wherein the first appliance is a washing machine appliance and the second appliance is a clothes dryer appliance.
